(19) United States
(12) Patent Application Publication
(10) Pub. No.: US 2025/0237094 A1
(43) Pub. Date: Jul. 24, 2025

(54) MOTOR VEHICLE DRIVE DEVICE

(71) Applicant: KIEKERT AKTIENGESELLSCHAFT, Heiligenhaus (DE)

(72) Inventor: Klaus HENSE, Kaarst (DE)

(73) Assignee: KIEKERT AKTIENGESELLSCHAFT, Heiligenhaus (DE)

(21) Appl. No.: 18/853,541

(22) PCT Filed: Mar. 24, 2023
(86) PCT No.: PCT/DE2023/100231

§ 371 Date: Oct. 2, 2024

(30) Foreign Application Priority Data
Apr. 14, 2022 (DE) 10 2022 109 174.0

(51) Int. Cl. E05B 77/34; E05B 81/06; E05B 85/02; H02K 5/10; H02K 11/215

(52) U.S. Cl. CPC E05B 77/34; E05B 81/06; E05B 85/02; H02K 5/10; H02K 11/215

(57) ABSTRACT

A motor vehicle drive device, which is equipped with at least one electromotive drive having a stator and rotor. The stator is arranged in a dry chamber and the rotor is arranged in a wet chamber of a housing made of plastic. Furthermore, the dry chamber has, in addition to the stator, at least one electronic unit. According to the invention, the housing is closed except for an inlet opening for a locking mechanism.

The invention relates to a motor vehicle drive device having at least one electromotive drive having a stator and a rotor, wherein the stator is arranged in a dry chamber and the rotor is arranged in a wet chamber of a housing of the motor vehicle drive device made of plastic, and wherein the dry chamber has, in addition to the stator, at least one electronic unit.

The general problem with motor vehicle drive devices is that they are sometimes exposed to harsh environmental conditions and thus to dust, rain, and moisture. This applies in particular to the so-called wet chamber of a housing of the motor vehicle drive device in question. This can essentially be attributed to the fact that such motor vehicle drive devices are often completely or partially open, so that dust or moisture can penetrate into the interior of the associated housing via the wet chamber created at this point.

The generic prior art according to DE 199 52 572 A1 relates to such a motor vehicle drive device, which is equipped with an electromotive drive in the form of a synchronous motor. The synchronous motor has a stator and a rotor. In order to protect the electrical parts of the stator from moisture, a pot-shaped support is provided so that the stator is at least partially enclosed by the support in such a way that it can act as a dividing wall between the wet and dry chambers. The dividing wall runs in the air gap between the stator and the rotor. In addition, a control device having at least one magnetoresistive sensor in the form of a Hall element is also implemented. The electronic control device, like the stator, is also located in the dry chamber.

The known motor vehicle drive device is used in connection with a window lifter or sunroof. Use in connection with a vehicle seat is also described above. This requires additional anti-pinch protection. The electronic control device is used to control the rotating field of the synchronous motor.

The use of the known motor drive unit in connection with a window lifter, a sunroof or even a vehicle seat implies a protruding and fragmented structure of the housing of the known motor vehicle drive device. In connection with the use of an electrically operated window lifter, a wall is provided which divides a vehicle door that accommodates the window lifter into the wet chamber and the dry chamber. The same applies to applications in connection with a sunroof. If a vehicle seat is to be adjusted using the known drive unit, a division into a wet chamber and a dry chamber is generally not necessary.

Another motor vehicle drive device according to DE 10 2020 134 972 A1 is used in connection with a motor vehicle locking device. At this point, an electromagnetic actuator is provided which is operatively coupled to a pawl as a component of a locking mechanism consisting of a rotary latch and a pawl. Using the electromagnetic actuator, the pawl can be moved between a catch position and a release position.

For this purpose, the electromagnetic actuator is implemented as a linear brushless motor configuration. It has a first element which moves back and forth along a linear straight path relative to the second element. The housing provided at this point and made of a plastic molded part can enclose the electromagnetic actuator in question and an associated control circuit.

Independently of this, the prior publication DE 20 2014 102 567 U1 concerns a motor vehicle lock having a locking mechanism and an actuator. The actuator has an electromagnet and can be switched back and forth between stable states by energizing the electromagnet. In addition, a permanent magnet arranged rotationally symmetrically to a pivot axis is provided, so that the actuator is ultimately equipped with a stator and a rotor, but any problems in connection with a dry chamber and a wet chamber are not addressed.

The prior art has fundamentally proven itself when it comes to motor vehicle drive devices and their design with an electromotive drive having a stator and a rotor. If an additional separation into the dry chamber and the wet chamber of a housing is made at this point, the housing is constructed in several parts and in a fragmented manner in the generic prior art according to DE 199 52 572 A1. Considering DE 10 2020 134 972 A1, the linear actuator implemented there cannot be used for many applications in connection with a motor vehicle locking device or a motor vehicle lock. This is because rotary movements are typically observed there.

The invention is based on the technical object of further developing such a motor vehicle drive device in such a way that a compact and simple structure is observed and at the same time an application in connection with motor vehicle locking devices or motor vehicle locks is possible.

In order to achieve this technical object, the invention proposes that the electronic unit is designed as an electrical component carrier having at least one carrier plate made of plastic and a conductor track structure in a generic motor vehicle drive device. Furthermore, it is advantageous to design the housing to be closed except for an inlet opening for a locking mechanism.

This means that, in contrast to the generic prior art according to DE 199 52 572 A1 with the previously described fragmented structure of the housing, the invention mostly makes use of a housing that is closed except for the inlet opening for the locking mechanism. As a result, the claimed motor vehicle drive device advantageously represents a component of a motor vehicle locking device. This means that the motor vehicle drive device is advantageously suitable for use with and in connection with a motor vehicle locking device and in particular a motor vehicle lock.

The housing of such a motor vehicle locking device and in particular of a motor vehicle lock is advantageously designed to be closed except for the inlet opening for the locking mechanism. The housing in question can in principle be made up of one or more parts. For example, the housing may have a base part and a cover that are connected to one another to provide an overall closed design.

A locking bolt can be inserted into the locking mechanism consisting of a rotary latch and a pawl via the inlet opening. The motor vehicle locking device or motor vehicle lock is typically connected in or to a motor vehicle door. The locking bolt, on the other hand, is located on the body side, so that when the associated motor vehicle door is closed, the locking bolt on the body side can be inserted into the rotary latch via the inlet opening and locked into place. The housing in question of the motor vehicle drive device and advantageously of the motor vehicle locking device, which is closed except for the inlet opening for the locking mechanism, is divided into the dry chamber and the wet chamber. The stator of the electromotive drive is arranged in the dry chamber together with the electronic unit. In contrast, the rotor is located in the wet chamber of the housing.

The invention is based on the additional finding that in this way the rotor can advantageously be equipped with a connected output shaft. The output shaft may be coupled directly or indirectly to at least one operating lever. In this way, a rotary drive is immediately available with the rotor and the connected output shaft in the wet chamber, for example to be able to carry out adjustment functions in the wet chamber.

These adjustment functions can in principle be individual functional states of the motor vehicle lock. It is particularly preferred if the operating lever is designed as a release lever and consequently the pawl can be acted upon directly or indirectly via the output shaft. This means that the locking mechanism can be opened electrically or by an electric motor in a simple manner via the rotor and the connected drive shaft in the wet chamber.

Furthermore, of particular inventive significance is the fact that the electronic unit is designed as an electrical component carrier having at least one carrier plate made of plastic and a conductor track structure.

Individual electrical/electronic components of the electronic unit can be contacted via the conductor track structure. The conductor track structure is in turn connected, for example, to a control unit inside an associated motor vehicle. For this purpose, the conductor track structure may be equipped with a socket for connecting a plug.

Within the scope of the invention, the design is such that the electrical component carrier not only accommodates the above-mentioned electrical/electronic components but usually also the stator. This means that the stator is mounted on or to the electrical component carrier. In addition, it has proven to be advantageous in this context if the stator is electrically connected to the conductor track structure.

A particularly compact and material-saving variant is characterized in that one wall of the dry chamber is designed entirely or partially as the above-mentioned electrical component carrier. This means that the housing made of plastic or at least one wall of the dry chamber takes on an additional functionality within the scope of the invention in that the wall in question simultaneously represents, in whole or in part, the electrical component carrier or its carrier plate. For this purpose, the conductor track structure can be built into the wall in question. Here, for example, the conductor track structure can be overmolded in connection with a plastic injection molding process for the production of the housing, and at the same time the electrical component carrier or the wall of the dry chamber is defined.

The dry chamber and the wet chamber are also separated from one another by at least one dividing wall. The dividing wall also represents an integral part of the housing, which according to the invention is designed to be closed except for the inlet opening. In addition, the design is such that the dividing wall is arranged in the air gap between the stator and the rotor.

In this way, two different embodiments are covered within the scope of the invention. In the first variant, the design is such that the stator concentrically encloses the rotor with the dividing wall interposed. The second variant is characterized by the fact that the stator and the rotor are axially opposite one another with the dividing wall interposed.

As already explained, the rotor usually has a connected output shaft. The operating lever can be subjected to a rotary movement directly or indirectly via the output shaft. If an electrical or electromotive opening of the locking mechanism is to be achieved via the electromotive drive, this means that the operating lever is designed as a release lever, which usually works directly on the pawl in order to be able to lift it from its locking engagement with the rotary latch.

As a result, a motor vehicle drive device and a motor vehicle locking device characterized by the motor vehicle drive device in question are provided. The motor vehicle locking device is advantageously a motor vehicle lock. This means that the motor vehicle drive device is advantageously suitable for use with and in connection with a motor vehicle locking device.

In any case, the housing of the motor vehicle drive device and advantageously the motor vehicle locking device and thus preferably the lock housing implemented at this point is designed to be closed except for the inlet opening for the locking mechanism. In addition, the housing in question and in particular the lock housing accommodates the electromotive drive having a stator and a rotor in its interior. The stator is located together with the electronic unit in the dry chamber, whereas the rotor is located in the wet chamber of the respective housing made of plastic. For this purpose, the dividing wall between the dry chamber and the wet chamber is implemented inside the housing, which is also advantageously placed in the air gap between the rotor and the stator.

In this way, a motor vehicle drive device and a motor vehicle locking device advantageously equipped therewith are provided, which have a compact and cost-effective design. This is because the housing and in particular the lock housing is not only simple in design and closed except for the inlet opening, but also takes on some additional functions. At least one wall of the dry chamber can be designed in whole or in part as an electrical component carrier, i.e., it generally has an inserted conductor track structure that is enclosed during the plastic injection molding process and which in turn serves to contact electrical/electronic components. The conductor track structure can also be used to contact the stator as a component of the electromotive drive. At the same time, the wall in question or the electrical component carrier that is formed in whole or in part at this point acts as a base or receptacle for the electrical/electronic components in question, just as the stator acts as a component of the electromotive drive. These are the main advantages.

In the following, the invention is explained in more detail with the aid of drawings showing only an exemplary embodiment; in the drawings:

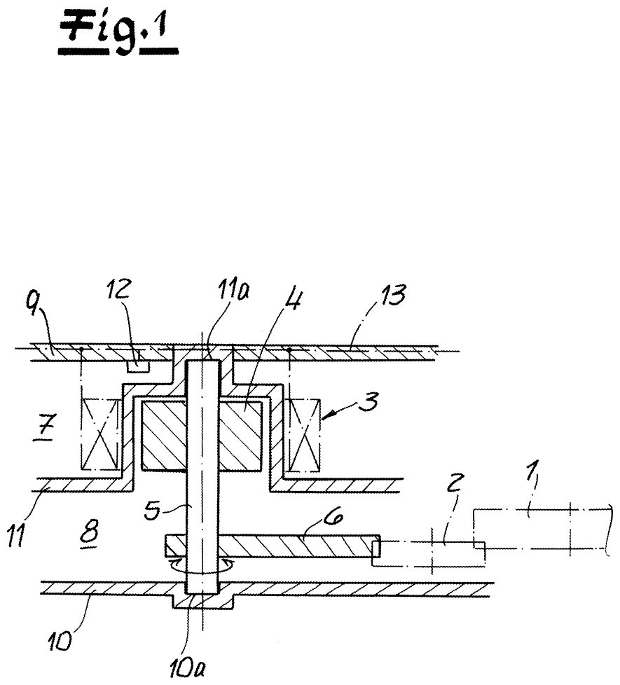

FIG. 1 shows a first embodiment of the motor vehicle drive device or motor vehicle locking device in a radial arrangement, and

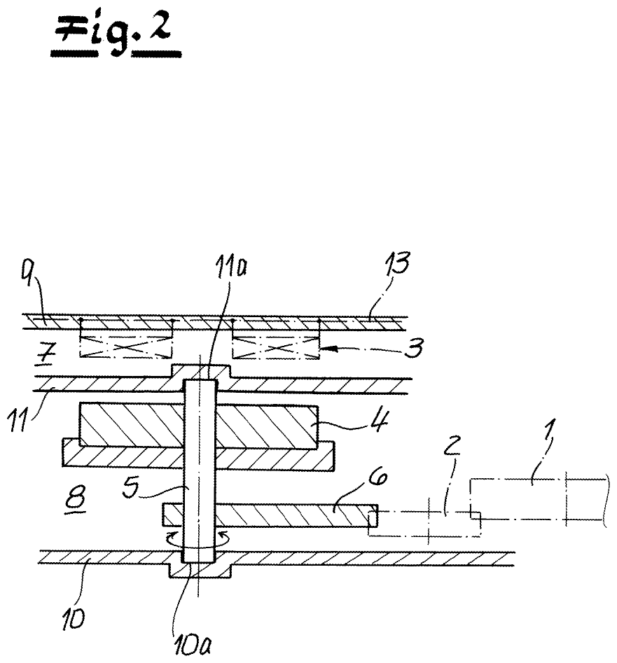

FIG. 2 shows a further second alternative embodiment of the motor vehicle drive device or motor vehicle locking device in an axial arrangement.

The drawings show a motor vehicle drive device. The motor vehicle drive device is, according to the embodiment, advantageously a component of a motor vehicle locking device. The motor vehicle locking device is, advantageously and according to the embodiment, a motor vehicle lock. The motor vehicle lock has a locking mechanism 1, 2 consisting of a rotary latch 1 and a pawl 2, which is only indicated in FIG. 1.

The basic structure of the drive device or locking device includes, in addition to the locking mechanism 1, 2, an electromotive drive 3, 4 having a stator 3 and a rotor 4. The rotor 4 has a connected output shaft 5. According to the embodiment, the output shaft 5 is coupled directly or indirectly to at least one operating lever 6. According to the embodiment, the operating lever 6 is designed in a non-limiting manner as a release lever 6, which is connected to or linked to the output shaft 5 in a rotationally fixed manner.

As a result, rotational movements of the rotor 4 and thus of the output shaft 5 about the axis defined thereby, as indicated in FIG. 1 by a double arrow, lead to the pawl 2 being able to be lifted from its locking engagement with the rotary latch 1 via the release lever 6. This means that the electromotive drive 3, 4 serves, within the scope of the embodiment and naturally not in a restrictive manner, to be able to open the locking mechanism 1, 2. It therefore functions as an electromotive opening drive.

Of particular importance is the fact that the stator 3 is arranged in a dry chamber 7 and the rotor 4 is arranged in a wet chamber 8 of a housing 9, 10, 11 made of plastic. The housing 9, 10, 11 made of plastic is generally a housing of the motor vehicle drive device, which according to the embodiment is designed as a housing of the motor vehicle locking device and preferably as a lock housing 9, 10, 11. The housing 9, 10, 11 has a base part 9 and a cover 10 as well as a dividing wall 11 which separates the dry chamber 7 from the wet chamber 8. In the embodiment, the base part 9 as well as the cover 10 and the dividing wall 11 can only be seen in part.

In any case, the housing 9, 10, 11 is completely closed except for an inlet opening (not shown) for the interaction of a locking bolt with the rotary latch 1 of the locking mechanism 1, 2. Furthermore, it can be seen that the dry chamber 7 has at least one electronic unit 9, 12, 13 in addition to the stator 3.

According to the embodiment, the electronic unit 9, 12, 13 is designed as an electrical component carrier 9, 12, 13 having at least one carrier plate 9 made of plastic and a conductor track structure 13. The electronic unit 9, 12, 13 also has one or more electrical or electronic components 12. According to the embodiment, a wall 9 of the dry chamber 7 is designed entirely or partially as the electrical component carrier 9, 12, 13 or its carrier plate 9. The wall in question and thus the carrier plate 9 of the electrical component carrier 9, 12, 13 according to the embodiment is the base part 9 of the housing 9, 10, 11 or a component of the base part 9 in question. The electronic component 12 may, for example, be a sensor with the aid of which the respective rotational angle position of the electromotive drive 3, 4 or of the rotor 4 relative to the stator 3 can be detected. The electronic component 12 can naturally also be designed as a microprocessor, a switch, etc.

Both the electronic component 12 in question and the stator 4 are accommodated by the electrical component carrier 9, 12, 13 in question or its carrier plate 9 and thus the wall of the housing 9, 10, 11 and specifically its base part 9. As a result, the wall 9 in question or the base part 9 assumes a dual function: on the one hand to seal and on the other hand as an electrical component carrier 9, 12, 13 or carrier plate 9 of the electrical component carrier 9, 12, 13 in question.

As already explained, the dry chamber 7 and the wet chamber 8 are separated from one another by the dividing wall 11. The dividing wall 11 runs through an air gap between the rotor 4 and the stator 3. This applies to both embodiments according to FIGS. 1 and 2.

The design according to FIG. 1 is such that the stator 3 concentrically encloses the rotor 4 with the dividing wall 11 interposed. The variant according to FIG. 2 is characterized in that the stator 4 and the rotor 3 are axially opposite one another with the dividing wall 11 interposed. In both cases, the dividing wall 11 also functions in such a way that it supports one axial end of the output shaft 5 in an associated receptacle 11a. The other axial end of the drive shaft 5 is held and supported in a corresponding receptacle 10a of the cover 10.

The rotor 4 is generally equipped with one or more permanent magnets or is composed of them. The stator 4, on the other hand, consists of one or more coils. In this way, an electromagnetic rotating field can be generated in the stator 3 or the coils, which the permanent magnets of the rotor 4 follow and thus cause the output shaft 5, which is coupled to the rotor 4 in a rotationally fixed manner, to rotate. This can be done and carried out in such a way that a certain angle of rotation of the output shaft 5 is controlled, which is also detected by means of the above-mentioned sensor 12 and transmitted to the body-side control unit in the example case.

This allows the pawl 2 to be specifically lifted from its engagement with the rotary latch 1 with the aid of the release lever 6 when the locking mechanism 1, 2 is in the closed position. As a result, the rotary latch can then open in a spring-assisted manner and release the previously held locking bolt. The associated motor vehicle door can be opened. This is of course only an exemplary application, because the operating lever 6 can generally also be used to represent other functional states inside the motor vehicle lock in the example case, for example to implement functional states such as “unlocked” or “locked” to name just a few examples.

### LIST OF REFERENCE SIGNS

Locking mechanism 1, 2
Rotary latch 1
Pawl 2
Drive 3, 4
Stator 3
Rotor 4
Stator 4
Output shaft 5
Operating lever 6
Release lever 6
Dry chamber 7
Wet chamber 8
Electronic unit 9, 12, 13
Electrical component carrier 9, 12, 13
Housing 9, 10, 11
Base part 9
Carrier plate 9
Cover 10
Receptacle 10a
Dividing wall 11
Receptacle 11a
Component 12

1. A motor vehicle drive device comprising:
a housing made of plastic,
at least one electromotive drive having a stator and a rotor, wherein the stator is arranged in a dry chamber of the housing and the rotor is arranged in a wet chamber of the housing, and wherein the dry chamber accommodates, in addition to the stator, at least one electronic unit, and
wherein the electronic unit is comprises an electrical component carrier having at least one carrier plate made of plastic and a conductor track structure.

2. The motor vehicle drive device according to claim 1, wherein the housing is closed except for an inlet opening for a locking mechanism.

3. The motor vehicle drive device according to claim 1, wherein the electrical component carrier accommodates electrical and electronic components and the stator.

4. The motor vehicle drive device according to claim 3, wherein the stator is electrically connected to the conductor track structure.

5. The motor vehicle drive device according to claim 2, wherein a wall of the dry chamber is designed entirely or partially as the electrical component carrier.

6. The motor vehicle drive device according to claim 1, wherein the stator concentrically encloses the rotor with a dividing wall of the housing interposed that separates the dry chamber from the wet chamber.

7. The motor vehicle drive device according to claim 1, wherein the stator and the rotor are axially opposite one another with a dividing wall of the housing interposed that separates the dry chamber from the wet chamber.

8. The motor vehicle drive device according to claim 1, wherein the rotor has a connected output shaft.

9. The motor vehicle drive device according to claim 8, further comprising an operating lever, wherein the output shaft is coupled directly or indirectly to the operating lever.

10. A motor vehicle locking device comprising the motor vehicle drive device according to claim 1 and a locking mechanism located within the housing.

11. The motor vehicle drive device according to claim 1, wherein the housing comprises a base part, a cover, and a dividing wall, wherein the dividing wall separates the wet chamber from the dry chamber.

12. The motor vehicle drive device according to claim 11, wherein the base part includes the carrier plate of the electrical component carrier.

13. The motor vehicle drive device according to claim 5, wherein the stator is mounted on the wall.

14. The motor vehicle drive device according to claim 6, wherein the dividing wall is arranged in an air gap between the stator and the rotor.

15. The motor vehicle drive device according to claim 9, wherein an axial end of the output shaft is supported by a dividing wall of the housing that separates the dry chamber from the wet chamber.
